(19) United States
(12) Patent Application Publication
(10) Pub. No.: US 2026/0071669 A1
(43) Pub. Date: Mar. 12, 2026

(54) ELECTROMECHANICAL ACTUATOR

(71) Applicant: Schaeffler Technologies AG & Co. KG, Herzogenaurach (DE)

(72) Inventors: Sebastian Krueger, Fürth (DE); Igor Mys, Erlangen (DE)

(73) Assignee: Schaeffler Technologies AG & Co. KG, Herzogenaurach (DE)

(21) Appl. No.: 19/105,373

(22) PCT Filed: Jul. 10, 2023
(86) PCT No.: PCT/DE2023/100519

§ 371 Date: Feb. 21, 2025

(30) Foreign Application Priority Data
Aug. 23, 2022 (DE) 10 2022 121 221.1
Jul. 7, 2023 (DE) 10 2023 117 976.4

(51) Int. Cl. F16H 25/24; B62D 5/04; C22C 38/00; C22C 38/02; C22C 38/06; C22C 38/42; C22C 38/46; C22C 38/58; F16H 25/22

(52) U.S. Cl. CPC F16H 25/24; C22C 38/002; C22C 38/02; C22C 38/06; C22C 38/42; C22C 38/46; C22C 38/58; F16H 25/2252; B62D 5/0445; F16H 2025/249

(57) ABSTRACT

An electromechanical actuator includes a planetary rolling screw drive having a plurality of planets, a driven cage guiding the plurality of planets, and a threaded spindle. The threaded spindle has a formed thread with a finish produced by martensite precipitation and strain hardening. The threaded spindle is formed from a steel including 0.4 to 1.5% by weight of Carbon, 12.0 to 22.0% by weight of Manganese, up to 4.0% by weight of Chromium, up to 0.5% by weight of Nickel, up to 0.3% by weight of Copper, up to 0.3% by weight of Vanadium, up to 0.3% by weight of Sulfur, up to 0.1% by weight of Phosphorus, up to 4.0% by weight of Silicon, up to 0.05% by weight of Aluminum, and a remainder of iron and smelting-induced impurities.

### CROSS-REFERENCE TO RELATED APPLICATIONS

This application is the United States National Phase of PCT Appln. No. PCT/DE2023/100519 filed Jul. 10, 2023, which claims priority to German Application Nos. DE102022121221.1 filed Aug. 23, 2022 and DE102023117976.4 filed Jul. 7, 2023, the entire disclosures of which are incorporated by reference herein.

### TECHNICAL FIELD

The present disclosure relates to an electromechanical actuator with a screw drive and a threaded spindle.

### BACKGROUND

WO 2012/048917 A1 discloses a tempering steel and its use as bar material, in particular for producing a threaded spindle. WO 2012/048917 A1 assumes that the material Cf53 is a widely used steel suitable for surface hardening or edge hardening and can be used, among other things, for the production of bolts, worms, gear wheels, shafts or spindles. The composition of the steel Cf53 is suitable in terms of rolling bearing technology to produce a fully load-bearing, martensitic hardened surface layer.

Based on this, WO 2012/048917 A1 describes a further developed tempering steel Cf53B, with which a hardening (600 HV) between 4 mm and 6 mm, measured from one end face of a face quenched specimen, can be achieved. The structure in the core usually consists of a mixture of pearlite and ferrite. The tempering steel according to WO 2012/048917 A1 contains, among other things, 0.0031% to 0.005% boron and at least 3.5 parts titanium in relation to one part nitrogen. The tempering steel Cf53B is suitable, among other things, for the production of a threaded spindle of a ball screw drive.

A ball screw drive known from DE 10 2017 121 942 A1, which is intended for use in a brake booster, has a threaded nut made of a martensitic hardened steel that does not rust in the presence of brake fluid. The steel contains at least 12% chromium by weight. In addition, the steel can contain, among other things, 0.4% to 1.3% carbon, up to 2% silicon, up to 2% manganese and up to 2% molybdenum. In particular, this can be steel with the material number 1.4108. The achievable hardness of the threaded nut is specified in DE 10 2017 121 942 A1 as 55 HRC.

EP 2 832 876 A1 describes a high-strength stainless steel wire which is said to have excellent heat deformation resistance. The steel wire is particularly suitable for the production of a high-strength spring. The spring is manufactured from cast steel, wherein a deformation-induced martensite formation index must lie within a specified range. A matrix of the steel wire from which the high-strength spring is formed may contain NiAl-based composite particles with particle sizes of 50 nm or less.

EP 2 465 964 A1 describes a Hadfield steel composition comprising 0.9 to 1.35% by weight carbon, 11 to 14% by weight manganese, a maximum of 0.8% by weight silicon, a maximum of 0.07% by weight phosphorus, a maximum of 0.05% by weight sulfur, at least 0.01% by weight hafnium, and the remainder iron and impurities. Such steels are non-magnetic, have low conductivity and show an improvement in their impact toughness through cold deformation.

EP 0 142 873 A1 discloses an austenitic manganese hard steel with 0.8 to 1.8% by weight carbon, 6 to 18% manganese by weight, 0 to 3% by weight chromium, 0 to 2% by weight nickel, 0 to 2.5% by weight molybdenum, 0 to 1% by weight silicon, at least 0.01% by weight titanium, at least 0.01% by weight vanadium, a total of 0.05 to 0.08% by weight titanium and vanadium, and the remainder iron, with a ratio of carbon to manganese in the range of 1:8 to 1:14. Such steel has the ability to harden during cold deformation.

DE 28 53 582 A1 describes a non-magnetic steel alloy with no more than 1.5% by weight carbon, 0.1 to 1.5% by weight silicon, 5 to 30% by weight manganese, 0.005 to 0.5% by weight nitrogen and at least one element from the group comprising 0.05 to 1% by weight sulfur, 0.05 to 1% by weight lead, 0.05 to 1% by weight selenium, 0.01 to 0.5% by weight tellurium, 0.001 to 0.05% by weight calcium, and the remainder iron.

GB 276 048 A describes another Hadfield manganese steel with at least 11% by weight manganese and a maximum of 1.6% by weight carbon.

The “Material Data Sheet 1.3401/X120Mn12”, Team Edelstahl, 2020, discloses a composition of a manganese steel with 1.1 to 1.3% by weight carbon, 12 to 13% by weight manganese, 0.3 to 0.5% by weight silicon, a maximum of 0.1% by weight phosphorus, a maximum of 0.04% by weight sulfur and a maximum of 1.5% by weight chromium.

The dissertation, “Höchstfeste nichtrostende austenitische CrMn-Stähle” (“High-strength Stainless Austenitic CrMn Steels”), Sascha Riedner, Ruhr University Bochum, 2010, describes, among other things, a study on austenitic steel of the type X120Mn12, which achieves a surface hardness of up to 700 HV through local work hardening under impact or shock loading.

Furthermore, reference is made to the following dissertation, which deals in particular with sheet metal forming for automotive applications:
“Verformungsinduzierte Martensitbildung bei mehrstufiger Umformung und deren Nutzung zur Optimierung der HCF-und VHCF-Eigenschaften von austenitischem Edelstahlblech” (“Deformation-induced martensite formation during multi-stage forming and its use to optimize the HCF and VHCF properties of austenitic stainless steel sheet”), Dipl.-Wirt.-Ing. Carsten Müller-Bollenhagen, Department of Mechanical Engineering at Faculty IV of the University of Siegen, April 2011

Among other things, the dissertation deals with phase transformations of metastable austenite.

As regards known compositions and properties of manganese steel, reference is made to the documents DE 28 46 930 A1, EP 2 803 736 A1, DE 866 893 B, WO 2017/021459 A1 and EP 0 205 869 A1 as examples. In general, manganese steel is characterized by high wear resistance, in particular under shock or impact loads.

### SUMMARY

The present disclosure provides material-technical advances for an electromechanical actuator compared to the aforementioned prior art. In particular, the aspect of wear occurring in screw drives, for example in electric actuators, is to be taken into account.

The present disclosure provides an electromechanical actuator operating with a screw drive. The electromechanical actuator includes a screw drive in the form of a planetary rolling screw drive, and the planetary rolling screw drive provided is a true-pitch screw drive having a driven cage, guiding a plurality of planets, and having a threaded spindle. The threaded spindle and/or the planets is/are formed from a steel of the following composition:

| | |
|---|---|
| C: | 0.4 to 1.5% by weight, |
| Mn: | 12.0 to 22.0% by weight, |
| Cr: | up to 4.0% by weight, |
| Ni: | up to 0.5% by weight, |
| Cu: | up to 0.3% by weight, |
| V: | up to 0.3% by weight, |
| S: | up to 0.3% by weight, |
| P: | up to 0.1% by weight, |
| Si: | up to 4.0% by weight, |
| Al: | up to 0.05% by weight, |

remainder: iron and smelting-induced impurities,
on the surface of which there is, at least in the region of a thread produced by a forming process on the threaded spindle and/or the planets, a finish produced by martensite precipitation and strain hardening.

A steel having the following composition is selected as the starting material for the production of the threaded spindle and/or the planets:

| | |
|---|---|
| C: | 0.4 to 1.5% by weight, |
| Mn: | 12.0 to 22.0% by weight, |
| Cr: | up to 4.0% by weight, |
| Ni: | up to 0.5% by weight, |
| Cu: | up to 0.3% by weight, |
| V: | up to 0.3% by weight, |
| S: | up to 0.3% by weight, |
| P: | up to 0.1% by weight, |
| Si: | up to 4.0% by weight, |
| Al: | up to 0.05% by weight, |

remainder: iron and smelting-induced impurities.

In particular, the manganese content is in the range of 12.0 to 14.0% by weight and the chromium content is a maximum of 1.8% by weight.

This starting product, which is present as a rod-shaped material, is deformed during the production of the threaded spindle and/or planet in such a way that martensite precipitation and work hardening occur on its surface, at least in the area of a thread to be produced using forming processes.

The austenitic manganese steel with the material number 1.3401 (X120Mn12) has proven to be particularly suitable for the production of the threaded spindle and/or the planets. This is a steel which contains 1.1% to 1.3% carbon, 12 to 13% manganese, 0.3 to 4.0% silicon, up to 0.1% phosphorus, up to 0.04% sulfur and up to 1.5% chromium, with the remainder being iron and impurities resulting from the melting process, each given in percent by weight, and which has a high resistance to wear, particularly when subjected to impact or shock. The manganese steel mentioned, which is also known as manganese hard steel, has otherwise proven itself as a material for the production of excavator teeth or jaw crushers, for example, and is particularly suitable for hot forming in the temperature range from 850° C. to 1050° C.

Surprisingly, it has been shown that a reduced carbon content, compared to the steel with the material number 1.3401, has positive effects. For example, a carbon content in the lower range of the specified interval, for example a C content (in % by weight) in the range of 0.4% to 0.8%, in the range of 0.4% to 0.6%, or in the more narrow range of a minimum of 0.4% and a maximum of 0.5%, ensures that the hardening is less abrupt and thus greater degrees of deformation can be achieved. In these cases it is also referred to as a weakened manganese steel.

The deformation of the rod-shaped starting material, which leads to martensite precipitation and work hardening, may initially involve a drawing process. In this drawing process, a rod that is a pre-product and does not yet have a thread structure can be stretched. This has the advantage that intermediate products of uniform shape and quality resulting from the drawing process can be made available for further processing into different end products, in particular threaded spindles and/or planets with different thread profiles. A threaded spindle is also referred to in cases where a spindle has a pitchless, i.e., groove-shaped, profile.

In all cases, the initial drawing process benefits the mechanical strength of the final product, i.e., the threaded spindle and/or the planets. Within the actuator, the threaded spindle is subjected to considerable axial forces in interaction with the existing counterpart, in particular in the form of a nut, a roller or a screw, wherein steep increases in force can occur. Both in method variants with an initial drawing process and in variants without such plastic elongation of the rod-shaped starting material, the thread can be formed by thread rolling. Optionally, heat treatment can be considered in addition to work hardening, wherein in any case the formation of the thread plays an essential role in martensite precipitation and work hardening. The heat treatment can be designed in several stages and in particular can include a subsequent temperature application, i.e., tempering. Deep freezing of the rod-shaped material can also be provided in an intermediate step.

Such steps, which follow heating the material to a temperature of more than 1000° C. and quenching, can reduce stresses in the forming area and stabilize the structure. As regards the forming of the rod-shaped starting material, forging, in particular of an end section of this material, may also be provided. At least the thread can be finished in a manner known in principle by machining.

The plastic forming process described is particularly suitable in various variants for the production of threaded spindles with a practically undetectable, extremely low distortion, as well as planets. A core strength of the workpiece of 800 MPa to 1080 MPa and a surface hardness of 650 HV and more can be achieved. This applies both to cases in which the workpiece is a threaded spindle and to cases in which components that interact directly or indirectly with a threaded spindle, such as nuts, bolts, rollers or planets, are machined as workpieces.

The threaded spindle is a spindle of a planetary rolling screw drive, wherein the planets of which also represent profiled shafts that can be manufactured from rod-shaped starting material of the composition specified above.

The electromechanical actuator may be used as a steering actuator of a motor vehicle, i.e., as an actuator of a front axle or rear axle steering. In this context, reference is made by way of example to the publications DE 10 2019 103 385 A1 and DE 10 2011 082 514 A1. Alternatively, the actuator according to the application can be used, for example, in an actuating mechanism of a stationary industrial plant.

The screw drive is designed as a planetary roller gear and there is a rotary drive of the cage that guides the planets of the screw drive. The planetary roller gear is designed as a pitch-accurate screw drive, wherein a less extreme transmission ratio is accepted compared to planetary roller gears with a driven threaded spindle or with a driven spindle nut.

### BRIEF DESCRIPTION OF THE DRAWINGS

In the following, an exemplary embodiment is explained in more detail with reference to drawings. In the figures:

FIG. 1 shows a section of a steering actuator with a planetary rolling screw drive intended for use in a rear axle steering system,

FIG. 2 shows a flow chart showing steps of manufacturing a threaded spindle of the steering actuator,

FIG. 3 shows a diagram showing the dependence of the hardness of the workpiece on the distance from the workpiece surface in the threaded spindle according to the application and in a comparative example (not claimed), and

FIG. 4 shows another diagram showing data recorded during a tensile test on the threaded spindle.

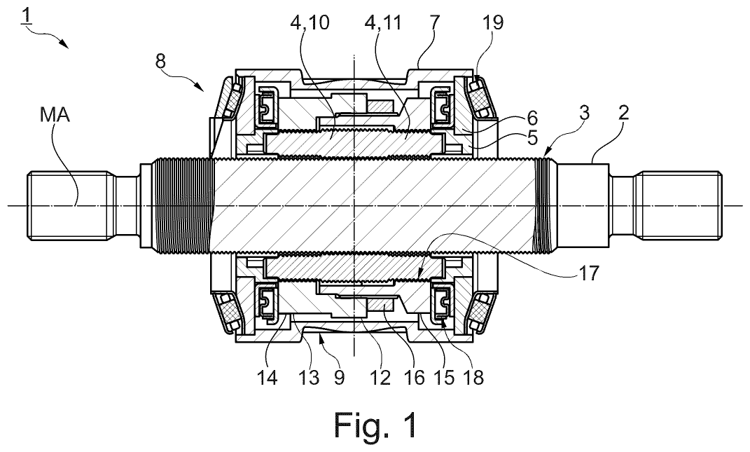

### DETAILED DESCRIPTION

An actuator designated overall with the reference symbol 1 is designed in the present case as an electromagnetic steering actuator for a rear axle steering of a motor vehicle.

The actuator 1 includes a threaded spindle 2, which is displaceable in its longitudinal direction in order to vary the steering angle of the rear wheels of a motor vehicle (not shown in detail). The threaded spindle 2 is aligned in the transverse direction of the vehicle. With regard to the basic structure and function of the actuator 1, reference is made to the cited prior art.

Multiple planets 4, which are guided in a cage 5, roll on the thread of the threaded spindle 2, which is designated 3 and is in this case a single-start thread. The cage 5 includes cage disks 6 on both end faces of the planets 4 as well as a cage sleeve 7 which surrounds the entire planets 4 in a ring shape and is arranged concentrically to the central axis designated MA of the threaded spindle 2 and thus of the entire actuator 1. The planets 4 and the cage 5 are components of a nut arrangement designated 8 overall. On the outer peripheral surface of the cage sleeve 7, an external toothing 9 is formed, which enables the drive of the entire cage 5 by means of a belt drive (not shown). The cage 5 is used as a rotating drive element, wherein the planetary rolling screw drive of the actuator 1 formed from the threaded spindle 2, and the nut arrangement 8 is designed as a pitch-accurate planetary rolling screw drive.

Each planet 4 has a central section 10 and two adjoining, comparatively thin end sections 11. Each of the sections 10, 11 has a profiling 12, 13 which, in contrast to the thread 3, is designed in the form of pitchless grooves. Only the central sections 10 of the planets 4 contact the threaded spindle 2. The end sections 11 of the planets 4, on the other hand, are lifted off of the thread 3 and instead engage in profiles 17 which are formed by nut parts 14, 15. The nut parts 14, 15, which are to be assigned to the nut arrangement 8, are adjusted such that a preload is provided between the nut parts 14, 15, the planets 4 and the threaded spindle 2.

The relative positioning of the nut parts 14, 15 to each other is fixed by means of a lock nut 16. The inherently rigid arrangement of the screwed together nut parts 14, 15 and the lock nut 16 is rotatably mounted in the cage 5 by means of two axial bearings 18. No drive power is fed into the nut parts 14, 15. The entire nut arrangement 8 is mounted by means of two tapered roller bearings 19 in a surrounding structure (not shown), i.e., an actuator housing. Among other things, an electric motor is attached to the actuator housing, which drives the belt drive that causes the cage 5 to rotate. Alternatively, the electric motor can be built into the actuator housing.

During operation of the electromechanical actuator 1, i.e., the steering actuator, rapidly increasing, almost sudden loads acting in the longitudinal direction of the threaded spindle 2 can occur. The thread 3 in particular must be able to withstand these loads.

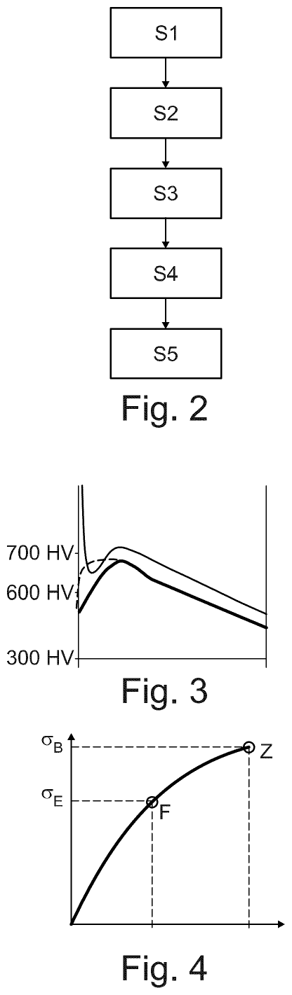

In the following, reference is made to the flow chart according to FIG. 2, in which steps S1 to S5 designate individual manufacturing steps in the manufacture of the threaded spindle 2. Alternatively or additionally, the production of the planet 4 can be achieved analogously.

In step S1, round steel is provided as the starting product. This is manganese steel X120Mn12 (material number 1.3401). Before the round steel is further processed, it can be plastically stretched—in step S1—which already has a positive effect on the desired hardening of the steel.

The starting product provided in step S1 is ground and rolled in steps S2 and S3. The rolling process produces the thread 3 in particular. The precipitation of martensite during forming facilitates the hardening.

Furthermore, a heat treatment takes place in step S3. In step S4, the threaded spindle 2 is machined by turning. Machining may also comprise other machining technologies, in particular milling. In the final step S5, the workpiece, i.e., the threaded spindle 2, is washed.

Mechanical properties of the threaded spindle 2 manufactured by the method according to FIG. 2 are shown in FIGS. 3 and 4. FIG. 3 shows the hardness curve in the work-hardened state (bold line), as well as in the work-hardened and heat-treated state (upper, thin line). For comparison, the hardness (300 HV) in the solution-annealed state is shown. As can be seen from FIG. 3, a surface hardness of approx. 550 HV is achieved by work hardening alone. The dashed line refers to work hardening with an increased degree of deformation. The additional heat treatment increases the surface hardness to at least 650 HV.

The simplified diagram in FIG. 4 shows the yield strength ØE (associated force: F) and tensile strength OB (associated force: Z) that can be determined by means of a tensile test. As can be seen from FIG. 4, there is a continuously increasing force with increasing elongation of the manganese steel from which the threaded spindle 2 is made. The core strength of the machined manganese steel used in threaded spindle 2 is in the range of 800 MPa to 1,080 MPa.

### REFERENCE NUMERALS

1 Actuator
2 Threaded spindle
3 Thread
4 Planet
5 Cage
6 Cage disk
7 Cage sleeve
8 Nut arrangement
9 External tooth system
10 Central section of a planet
11 End section of a planet
12 Profiling of the central section
13 Profiling of the end section
14 Nut part
15 Nut part
16 Lock nut
17 Profiling of a nut part
18 Thrust bearing
19 Tapered roller bearing
σ_{E} Yield strength
σ_{B} Tensile strength
F Force
MA Central axis
S1, . . . S5 Steps
Z Force

1. An electromechanical actuator, comprising a screw drive in the form of a planetary rolling screw drive, wherein the planetary rolling screw drive provided is a true-pitch screw drive having a driven cage, guiding a plurality of planets, and having a threaded spindle, wherein the threaded spindle and/or the planets is/are formed from a steel of the following composition:
C: 0.4 to 1.5% by weight,
Mn: 12.0 to 22.0% by weight,
Cr: up to 4.0% by weight,
Ni up to 0.5% by weight,
Cu: up to 0.3% by weight,
V: up to 0.3% by weight,
S: up to 0.3% by weight,
P: up to 0.1% by weight,
Si: up to 4.0% by weight,
Al: up to 0.05% by weight,
remainder: iron and smelting-induced impurities,
on the surface of which there is, at least in the region of a thread produced by a forming process on the threaded spindle and/or the planets, a finish produced by martensite precipitation and strain hardening.

2. The electromechanical actuator according to claim 1, wherein the threaded spindle and/or the planets is/are made of manganese steel (material number 1.3401).

3. The electromechanical actuator according to claim 1, wherein the threaded spindle is formed from a rod-shaped starting material made of steel.

4. The electromechanical actuator according to claim 3, wherein the rod-shaped starting material is formed in a drawing process.

5. The electromechanical actuator according to claim 3, wherein at least one section of the rod-shaped starting material is forged.

6. The electromechanical actuator according to claim 1, wherein the threaded spindle and/or the planets is/are at least partially work hardened by thread rolling.

7. The electromechanical actuator according to claim 1, wherein the threaded spindle and/or the planet continue(s) to be heat treated.

8. The electromechanical actuator according to claim 1, which is designed as a steering actuator.

9. An electromechanical actuator, comprising:
a planetary rolling screw drive, comprising:
a plurality of planets;
a driven cage guiding the plurality of planets; and
a threaded spindle comprising a formed thread having a finish produced by martensite precipitation and strain hardening, the threaded spindle being formed from a steel comprising:
0.4 to 1.5% by weight of Carbon;
12.0 to 22.0% by weight of Manganese;
up to 4.0% by weight of Chromium;
up to 0.5% by weight of Nickel;
up to 0.3% by weight of Copper;
up to 0.3% by weight of Vanadium;
up to 0.3% by weight of Sulfur;
up to 0.1% by weight of Phosphorus;
up to 4.0% by weight of Silicon;
up to 0.05% by weight of Aluminum; and
a remainder of iron and smelting-induced impurities.

10. The electromechanical actuator of claim 9, wherein the threaded spindle is made from manganese steel (Din material number 1.3401).

11. The electromechanical actuator of claim 9, wherein the threaded spindle is formed from a rod.

12. The electromechanical actuator of claim 11, wherein the rod is formed in a drawing process.

13. The electromechanical actuator of claim 11, wherein an end section of the rod is forged.

14. The electromechanical actuator of claim 9, wherein the formed thread is produced by thread rolling that work hardens the threaded spindle.

15. The electromechanical actuator of claim 9, wherein the threaded spindle is heat treated.
